(19) United States
(12) Patent Application Publication
(10) Pub. No.: US 2025/0316678 A1
(43) Pub. Date: Oct. 9, 2025

(54) APPARATUS AND METHOD FOR MANUFACTURING SECONDARY BATTERY FOR IMPROVEMENT OF BRITTLENESS OF ELECTRODE PLATE

(71) Applicant: SAMSUNG SDI CO., LTD., Yongin-si (KR)

(72) Inventor: Hyunjin Lee, Yongin-si (KR)

(21) Appl. No.: 18/961,258

(22) Filed: Nov. 26, 2024

(30) Foreign Application Priority Data
Apr. 9, 2024 (KR) 10-2024-0047741

(51) Int. Cl. H01M 4/04

(52) U.S. Cl. CPC H01M 4/0471; H01M 4/0435

(57) ABSTRACT

A secondary battery manufacturing apparatus includes: a coating unit configured to coat a mixture on a substrate of an electrode plate of an electrode assembly of a secondary battery and to discharge the coated electrode plate; and a cooler configured to cooling the coated electrode plate to improve brittleness of the electrode plate.

### CROSS-REFERENCE TO RELATED APPLICATION

The present application claims priority to and the benefit of Korean Patent Application No. 10-2024-0047741, filed on Apr. 9, 2024, in the Korean Intellectual Property Office, the entire disclosure of which is incorporated herein by reference.

### BACKGROUND

### 1. Field

Aspects of embodiments of the present disclosure relate to a secondary battery manufacturing apparatus and method for improving brittleness of an electrode plate.

### 2. Description of the Related Art

Different from primary batteries that are not designed to be (re)charged, secondary batteries are designed to be discharged and recharged. Generally, a secondary battery includes an electrode assembly including (or composed of) a positive electrode plate, a negative electrode plate, and a separator. The positive/negative electrode plates may be manufactured through processes, such as rolling, drying, slitting, and notching, subsequent to a process of coating an active material on a substrate. The electrode assembly is manufactured by arranging the separator between the positive/negative electrode plates manufactured in this way and applying a winding method or a stack method.

The secondary battery manufacturing process may include a coating process of coating an active material mixture on one side or both sides of an electrode substrate and a roll pressing process of compressing and stretching the electrode plate coated with the mixture during the coating process with a roller, making the electrode plate thin and flat to improve density and to allow lithium ions to move smoothly to increase the output and performance of the battery.

When the electrode plate coated with the mixture is moved from a high temperature environment to a low temperature environment during a drying process or a heated rolling process, a binder material included in the coated mixture is crystallized, causing the electrode plate to become hard (e.g., brittle) and less flexible. The electrode plate, exhibiting reduced flexibility, is more likely to be broken or fractured when the electrode assembly is manufactured and may negatively influence battery performance and safety by deformation of the electrode plate due to charging and discharging during the lifespan of the secondary battery.

The above information disclosed in this Background section is for enhancement of understanding of the background of the present disclosure, and therefore, it may contain information that does not constitute the related (or prior) art.

### SUMMARY

The degree of crystallization of the binder material increases as when the temperature thereof slowly decreases. Accordingly, embodiments of the present provide a secondary battery manufacturing apparatus and method that improve brittleness of an electrode plate by quickly cooling a coated electrode plate to lower the degree of crystallization of a binder material.

According to an embodiment, a secondary battery manufacturing apparatus includes: a coating unit configured to coat a mixture on a substrate of an electrode plate of an electrode assembly of a secondary battery and to discharge the coated electrode plate; and a cooler configured to cool the coated electrode plate to improve brittleness of the electrode plate.

According to another embodiment, a secondary battery manufacturing method includes: coating a mixture on a substrate of an electrode plate of an electrode assembly of a secondary battery and discharging the electrode plate; and a cooling the coated electrode plate to improve brittleness of the electrode plate.

Aspects and features of the present disclosure are not limited to the above-described aspects and features, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 illustrates a cross-sectional view of a prismatic secondary battery;

FIG. 5 is a schematic diagram of a process of manufacturing an electrode plate of the electrode assembly illustrated in FIG. 1;

FIG. 6 is a schematic diagram describing a secondary battery manufacturing apparatus and method according to an embodiment of the present disclosure;

FIG. 7 is a schematic diagram describing a secondary battery manufacturing apparatus and method according to another embodiment of the present disclosure;

FIG. 8 illustrates a secondary battery manufacturing apparatus according to an embodiment of the present disclosure;

FIG. 9 illustrates a secondary battery manufacturing apparatus according to another embodiment of the present disclosure.

FIG. 10 illustrates a secondary battery manufacturing apparatus according to another embodiment of the present disclosure;

FIG. 11 illustrates a secondary battery manufacturing apparatus according to another embodiment of the present disclosure;

FIG. 12 illustrates a secondary battery manufacturing apparatus in which coolers are installed on both top and bottom sides of an electrode plate according to another embodiment of the present disclosure;

FIG. 13 is a schematic diagram describing a secondary battery manufacturing apparatus and method according to another embodiment of the present disclosure;

FIG. 14 is a schematic diagram of an aspect of a secondary battery manufacturing apparatus applicable to a multi-row coated electrode plate according to an embodiment of the present disclosure;

FIG. 15 is a schematic configuration diagram of a controller;

FIG. 16 is a view of a secondary battery module in which secondary batteries are arranged according to one or more embodiments of the present disclosure;

FIG. 17 is a view of a secondary battery pack including the secondary battery module illustrated in FIG. 16; and

FIG. 18 is a schematic view of a vehicle including the secondary battery pack illustrated in FIG. 17.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of one or more embodiments of the present disclosure and do not represent all of the aspects of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, when a certain parameter is referred to as being uniform in a given region, it may mean that it is uniform in terms of an average.

The controller and/or any other relevant devices or components according to embodiments of the present disclosure described herein may be implemented utilizing any suitable hardware, firmware (e.g., an application-specific integrated circuit), software, and/or a suitable combination of software, firmware, and hardware. For example, the various components of the controller may be formed on one integrated circuit (IC) chip or on separate IC chips. Further, the various components of the controller may be implemented on a flexible printed circuit film, a tape carrier package (TCP), a printed circuit board (PCB), or formed on a same substrate as the controller. Further, the various components of the controller may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present disclosure.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled, or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

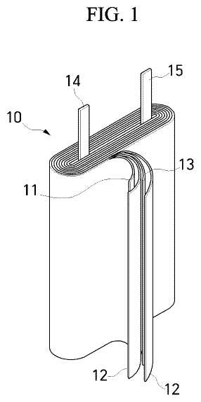

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

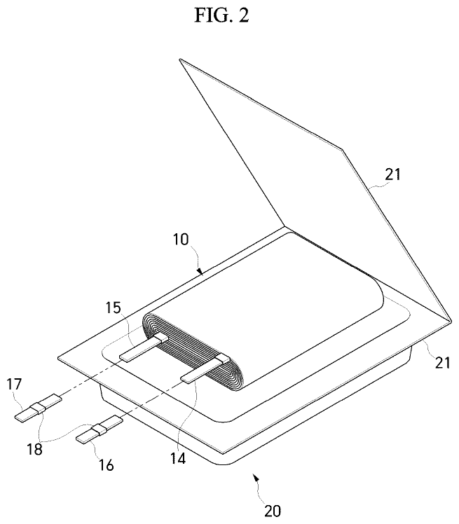

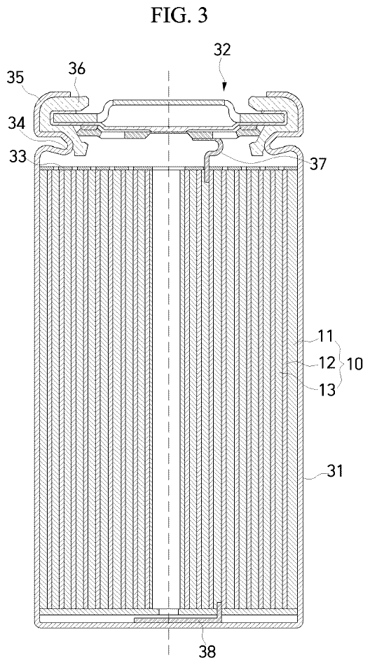

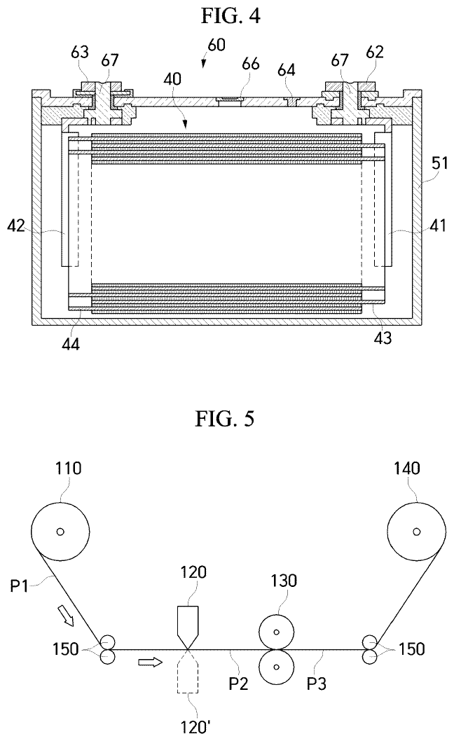

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

FIG. 2 schematically illustrates the pouch-type secondary battery.

The pouch-type secondary battery includes an electrode assembly 10 and a pouch 20 that accommodates the electrode assembly 10.

The electrode assembly 10 may be the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with (e.g., covered by) a tab film 18 for insulation from the pouch 20.

The pouch 20 may be sealed by having sealing parts 21 at the edges thereof come into contact with each other while accommodating the electrode assembly 10 therein, and the sealing may be achieved with the tab film 18 interposed between the sealing parts 21. The sealing parts 21 of the pouch 20 may each be made of a thermal fusion material that generally exhibits weak adhesion to metal. Thus, the pouch 20 may be fused together by interposing the thin film 18 between the sealing parts 21 to ensure a sufficient seal.

FIG. 3 illustrates a cylindrical secondary battery. As shown in FIG. 3, a secondary battery may include an electrode assembly 10, a case 31 accommodating the electrode assembly 10 and an electrolyte therein, a cap assembly 32 coupled to an opening in the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms an external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of a gasket 36 and the cap assembly 32. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 shows an internal structure of a prismatic secondary battery.

As shown in FIG. 4, a prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies 40 may be stacked such that long sides of the electrode assemblies 40 are adjacent to each other and accommodated in the case 51, and the number of electrode assemblies 40 in the case 51 is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As described above, in embodiments in which the first electrode tab 43 and the second electrode tab 44 are located at the top of the electrode assembly 40, the first and second current collectors are located at the top of the electrode assembly 40.

As illustrated in FIG. 4, the first current collector 41 and the second current collector 42 are connected to the first terminal 62 and the second terminal 63 through connection members 67, respectively. In some embodiments, the connection members 67 may each have an outer peripheral surface that is threaded and may be fastened to the first terminal 62 and the second terminal 63 by screwing. However, the present disclosure is not limited thereto. In other embodiments, the connection members 67 may be coupled to the first terminal 62 and the second terminal 63 by riveting or welding.

FIG. 5 is a schematic diagram describing a process for manufacturing an electrode plate (e.g., the first electrode plate 11 or the second electrode plate 13) of the electrode assembly 10 illustrated in FIG. 1 or the electrode assembly 40 illustrated in FIG. 4.

A supply roll 110 is a roll on which a substrate P1 for an electrode plate is wound. When an apparatus for manufacturing electrode plates according to embodiments the present disclosure is used to manufacture a positive electrode plate, the substrate P1 may be a metal foil including (or containing) aluminum (Al), for example. Alternatively, when the apparatus for manufacturing electrode plates according to embodiments of the present disclosure is used to manufacture a negative electrode plate, the substrate P1 may be a metal foil including (or containing) copper (Cu) or nickel (Ni).

A transfer roller 150 may be an idle roller that guides the substrate P1 as it is unwounded from the supply roll 110 or a drive roller that applies a pulling force to unwind the substrate P1 from the supply roll 110. FIG. 5 illustrates an embodiment including a total of four transfer rollers 150 as an example only, and the number and positions of transfer rollers may be varied.

A coating unit 120 forms a coating layer by coating the substrate P1 with an electrode material slurry that is previously prepared. The slurry for coating includes (or contains) an active material. When the apparatus for manufacturing electrode plates according to embodiments of the present disclosure is used to manufacture the positive electrode plate, the slurry may include (or contain) an active material containing a transition metal oxide, a binder, a volatile solvent, and the like, for example. When the apparatus is used to manufacture the negative electrode plate, the slurry may be prepared with (e.g., may include) an active material containing a transition metal oxide, a binder, a solvent, or the like. Moreover, both surfaces, namely the upper and lower surfaces, of the substrate P1 may be coated (e.g., may be concurrently or simultaneously coated) by adding a second coating unit 120′, having the same configuration as the coating unit 120 illustrated in FIG. 5, to the lower surface of the substrate P1.

A press unit (e.g., a rolling unit) 130 includes a rolling roller to compresses an electrode plate P2 coated with the slurry (e.g., a mixture of materials) by the coating unit 120 to produce a high-capacity and high-density secondary battery.

A winding roll 140 is a roll that winds and accommodates an electrode plate P3 coated by the coating unit 120 and rolled by the press unit 130.

The rolling process by the press unit 130 may include heated rolling, which involves rolling while applying heat to the coated electrode plate, and room temperature rolling, which involves rolling at room temperature without applying heat to the coated electrode plate. In the case of the room temperature rolling, a drying process may be additionally included to ensure secure fixation (or binding) of the coating layer onto the electrode plate. For example, a drying furnace may be added between the coating unit 120 and the winding roll 140 to dry or solidify the electrode plate P2 coated with the mixture of an active material and a binder. The drying furnace may include a heat source, and this heat source may be physically separate from the press unit 130 or may be integrated into the press unit 130. For example, when the press unit 130 is configured in the form of a roller, a heat source may be installed within the roller so that the roller may heat the coating layer while rolling the coating layer, and thus, the press unit 130 may have a drying function.

When the rolling process by the press unit 130 is performed by using the heated rolling method, the binder material (e.g., PVDF) included in the mixture is crystallized while the electrode plate is moved from a high temperature state by the heated rolling to an ambient temperature environment such that the electrode plate may become brittle and less flexible. The binder material is well crystallized when the temperature slowly decreases.

Such crystallization of the binder material may occur not only during heated rolling but also when the electrode plate dried at a high temperature in the drying furnace after the coating process meets the room temperature atmosphere before entering the rolling process.

Accordingly, when a cooler configured to cool the electrode plate faster than a natural cooling rate is applied to the heated rolling or the drying process, the brittleness of the electrode plate can be improved (e.g., reduced) by lowering the degree of crystallization of the binder material, which increases when the temperature slowly decreases, as described above.

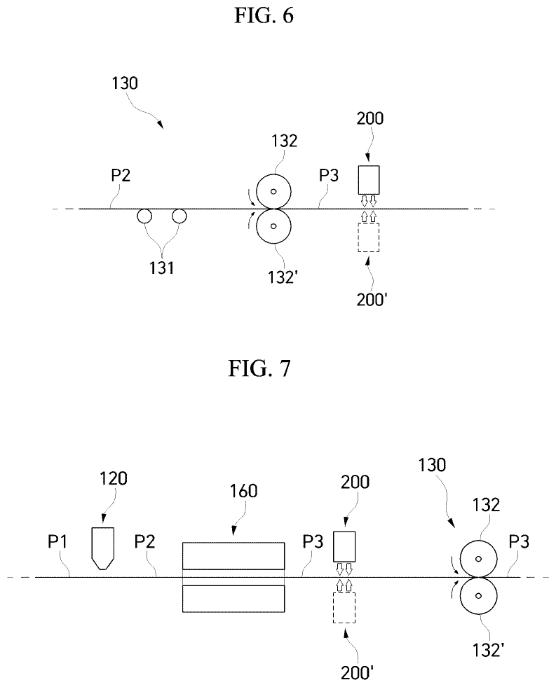

FIG. 6 is a schematic diagram of an apparatus and a method for manufacturing a secondary battery for improving brittleness of an electrode plate according to an embodiment of the present disclosure that uses heated rolling.

In FIG. 6, the press unit 130 performs heated rolling by using a preheating roll 131 that heat (e.g., that preheats) the electrode plate P2, which is coated in the previous coating process, and main rolls 132 and 132′ for heating (e.g., further or subsequent heating). A cooler 200 may be installed after the electrode plate P3 rolled by the main roll 132 is discharged from the main roll 132. In the illustrated embodiment, the cooler 200 is located relatively near to the rear end of the heated press unit 130; however, the cooler 200 may be installed at any location after the heated press unit 130. For example, the cooler 200 may be located in a slitting process or a notching process after the rolling process.

To increase the cooling effect (or cooling ability) of the cooler 200 or to cool a double-sided coated electrode plate, a second cooler 200′ may be additionally installed below the cooler 200. The cooler 200 may be implemented as a cooling fan that blows cold air directly onto the electrode plate or as a cold air radiator that radiates cold air by bringing a cold air generation end (e.g., a cold air outlet) close to the electrode plate.

FIG. 7 is a schematic diagram of an apparatus and a method for manufacturing a secondary battery for improving brittleness of an electrode plate that features high temperature drying of an electrode plate in a drying furnace 160 installed at the rear end of the coating unit 120 before the room temperature rolling process.

In FIG. 7, the cooler 200 may be installed before the electrode plate P2, which is coated by the coating unit 120, passes through the drying furnace 160 and the high-temperature dried electrode plate P2′ is rolled by the main rolls 132 and 132′ of the room temperature press unit 130. Also, to increase the cooling effect (e.g., cooling ability) of the cooler 200 or to cool the double-sided coated electrode plate, the second cooler 200′ may be additionally installed below the cooler 200. Even in such an embodiment, the cooler 200 may be implemented as a cooling fan or a cold air radiator.

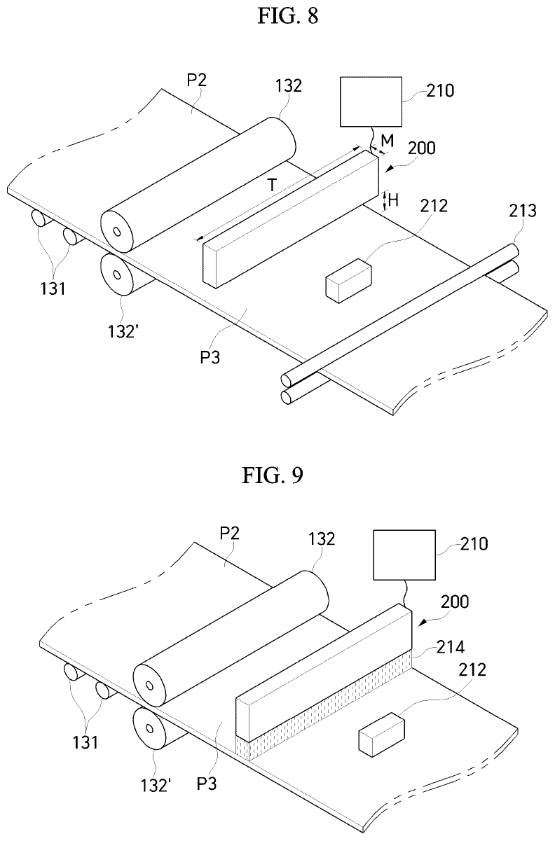

FIG. 8 illustrates an apparatus for manufacturing a secondary battery for improving brittleness of an electrode plate that uses the heated rolling method illustrated in FIG. 6.

At a portion where the electrode plate P3 formed by rolling the coated electrode plate P2 by the preheating roll 131 and the heating main rolls 132 and 132′ is discharged, the cooler 200 for cooling the electrode plate P3 is installed at a position away from (e.g., spaced apart from) the surface of the electrode plate P3 by a distance H. The distance H from the surface of the electrode plate P3 may be in a range of about 1 cm to about 10 cm but is not limited thereto.

At least one of the vertical movement or movement to another position, activation or deactivation, and temperature adjustment of the cooler 200 may be controlled by a movement mechanism controlled by a controller 210.

The larger the difference between the temperature at which the electrode plate P3 is cooled by the cooler 200 and the previous temperature of the electrode plate P3, the lower the degree of crystallization of the binder material in the mixture coated on the electrode plate, which reduces the brittleness of the electrode plate. To this end, the temperatures of the preheating roll 131 and the main rolls 132 and 132′ of the heated press unit 130 may be set as higher as possible than that of the general heated press unit 130. For example, the temperature of the preheating roll 131 may be set in a range of about 80° C. to about 150° C. and the temperature of the main rolls 132 and 132′ may be set in a range of about 60° C. to about 100° C.

Referring back to FIG. 8, when a transverse direction (TD) length T of the cooler 200 is equal to or larger than the width of the electrode plate P3, the electrode plate P3 may be more uniformly cooled. The cooler 200 may have a machine direction (MD) length M in the range of about 5 cm to about 30 cm. When the machine direction length M is too short, the electrode plate P3 may be insufficiently cooled depending on the moving speed of the electrode plate P3. When the machine direction length M is too long, a part of the electrode plate P3 may be excessively cooled, and the cooler 200 may be unnecessarily costly and large.

In some embodiments, a temperature sensor 212 may be additionally installed to measure the temperature of the electrode plate P3 after it is cooled by the cooler 200. The temperature sensor 212 may be an infrared thermal imaging non-contact temperature sensor that may measure temperature without contacting the surface of the electrode plate P3 but is not limited thereto. In some embodiments, the temperature sensor 212 may be connected to the controller 210 and may transmit temperature measurement data to the controller 210. The controller 210 may receive the temperature measurement data from the temperature sensor 212 and control the rolling speed of the press unit 130 (e.g., the moving speed of the electrode plate P3), the activation or deactivation of the cooler 200, the position movement of the cooler 200, and the like to maintain the appropriate temperature of the electrode plate P3.

In some embodiments, the temperature of the electrode plate P3 monitored by the temperature sensor 212 may be in a range of about 3° C. to about 7° C. This temperature may be changed depending on the set temperature of the preheating roll 131 and/or the set temperature of the main rolls 132 and 132′. An operator may set or change this monitored temperature in the controller 210 according to process conditions. The controller 210 may use an advanced process control (APC) program to automatically adjust the air volume or cooling temperature of the cooler 200 when the temperature sensed by the temperature sensor is higher or lower than a reference (or set) value.

In FIG. 8, the electrode plate P3 may be cooled by the cooler 200 and then may enter a subsequent process through a guide roll 213. This guide roll 213 guides the electrode plate P3 to the subsequent process (e.g., slitting, notching, etc.) without deformation or jamming.

FIG. 9 illustrates an apparatus for manufacturing a secondary battery for improving brittleness of an electrode plate according to another embodiment of the present disclosure.

A curtain 214 forming a space between the lower part of the cooler 200 and the electrode plate P3 may be installed. This curtain 214 increases the cooling efficiency of the electrode plate P3 and ensures a more uniform cooling effect by concentrating cold air radiated from the lower part of the cooler 200 on a portion of the electrode plate at the space formed by the curtain 214.

The material of the curtain 214 may be selected from among a soft material, such as cotton, non-woven fabric, sponge, vinyl, or fabric that will not damage the electrode plate P3 while maintaining a temperature in an internal space. In another embodiment, the curtain 214 may be an air curtain that forms a space by releasing air downwardly from the lower outer edge of the cooler 200 to block outdoor (or external) air. In such an embodiment, the formation and removal of the air curtain may be controlled by the controller 210.

FIG. 10 illustrates an apparatus for manufacturing a secondary battery for improving brittleness of an electrode plate according to another embodiment of the present disclosure.

To increase or maximize the cooling of the electrode plate, cooling rolls 216 and 216′ may be applied together with the cooler 200. In the embodiment shown in FIG. 8, because the cooler 200 does not contact the surface of the electrode plate P3, there is a possible loss in cooling efficiency. However, in the embodiment shown in FIG. 10, cooling rolls 216 and 216′ are applied in the form of a roll in contact with the electrode plate P3.

FIG. 10 illustrates an embodiment in which an inlet pipe 215 and an outlet pipe 217 are provided in the cooling rolls 216 and 216′ to allow cooling water to pass through an internal space thereof. However, the cooling action of the cooling rolls 216 and 216′ is not limited to that illustrated in FIG. 10. For example, a PTC element or another heating element may be installed inside the cooling rolls 216 and 216′ and controlled to achieve a cooling effect.

Even in the present embodiment, the controller 210 may be designed to control the temperature of the cooling rolls 216 and 216′. In FIG. 10, descriptions of the cooler 200, the controller 210, and the temperature sensor 212 are omitted or only briefly provided because they are similar to the above-described embodiments.

In the embodiment shown in FIG. 10, the cooling rolls 216 and 216′ are installed on both sides of the electrode plate below the cooler 200, respectively. However, the present disclosure is not limited thereto, and in another embodiment, two or more cooling rolls 216 and 216′ may be installed on one side of the electrode plate or may be installed on both sides of the electrode plate, respectively. In another embodiment, the cooling rolls 216 and 216′ may be spaced further apart from the cooler 200 to act as the guide roll 213 as illustrated in FIG. 8.

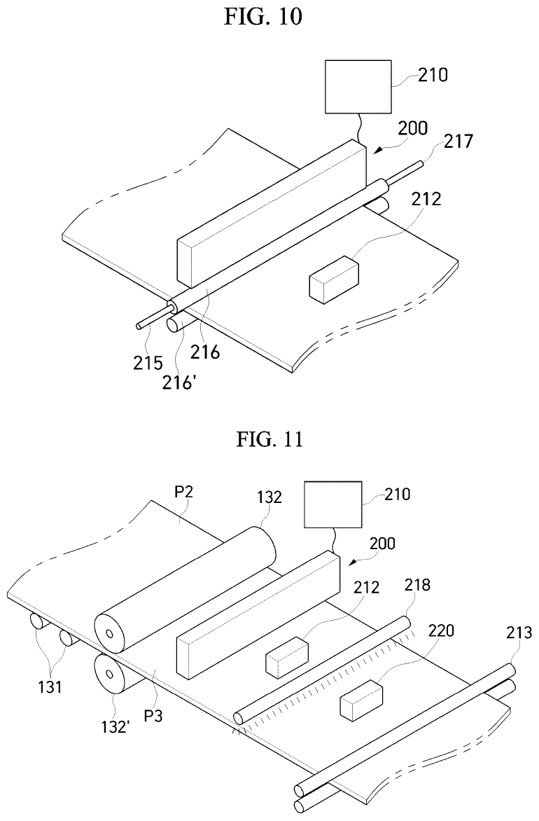

FIG. 11 illustrates an apparatus for manufacturing a secondary battery for improving brittleness of an electrode plate according to another embodiment of the present disclosure.

According to this embodiment, a warmer 218 may be added after the cooler 200. When the electrode plate P3 passes through the guide roll 213 after having its temperature lowered by (e.g., after being cooled by) the cooler 200 and enters a subsequent process in which the running direction of the electrode plate is changed, the electrode plate P3 may be bent and cracks may occur because it is at a relatively low temperature. Accordingly, in this embodiment, the temperature of the electrode plate P3 is increased using the warmer 218. In various embodiments, the warmer 218 may be implemented as an IR-heater or a hot air blower, and in another embodiment, the warmer 218 may be implemented by adding a heating function to the guide roll 213.

A second temperature sensor 220 may be added to control the temperature of the additional warmer 218. The second temperature sensor 220 may measure the temperature of the electrode plate P3 and transmit the measured temperature to the controller 210 so that the temperature of the electrode plate P3 at a corresponding position may be maintained in a range of about 8° C. to about 12° C. The controller 210 may receive the measured temperature value from the second temperature sensor 220 and may control the rolling speed of the press unit 130 (e.g., the moving speed of the electrode plate P3) and/or the temperature of the warmer 218.

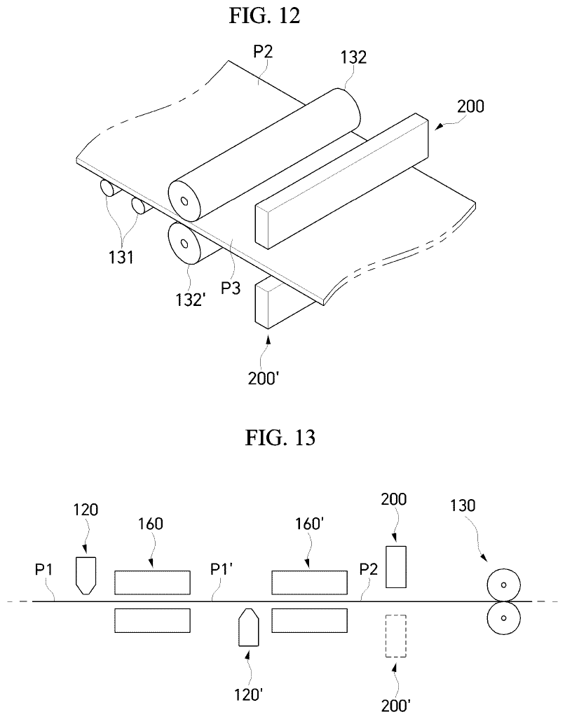

FIG. 12 illustrates an embodiment of an apparatus for manufacturing a secondary battery for improving brittleness of an electrode plate in which the cooler 200 is installed on both top and bottom sides of the electrode plate P3. In the embodiment shown in FIGS. 8 to 11, the cooler 200 is illustrated as being installed only above the electrode plate P3, but a first cooler 200 and a second cooler 200′ may be installed on the upper and lower surfaces of the electrode plate P3, respectively, to reduce the degree of crystallization of a coating mixture. The embodiment shown in FIG. 12 may be applied when a previous coating unit performs double-sided coating. Also, all of the various configurations shown in FIGS. 8 to 11 and described above may be modified as shown in FIG. 12.

FIG. 13 illustrates a secondary battery manufacturing apparatus in which the cooler 200 is installed between the drying furnace 160 installed at the rear end of the coating unit 120 and the room temperature press unit 130 according to an embodiment of the present disclosure. FIG. 13 illustrates an embodiment in which, when the first and second sides of the electrode plate P1 are coated and a first drying furnace 160 for drying a first side-coated electrode plate P2 and a second drying furnace 160′ for drying a second side-coated electrode plate P2′ are separately installed, a first cooler 200 and a second cooler 200′ are installed between the rear end of the second drying furnace 160′ and the room temperature press unit 130.

That is, FIG. 7 illustrates an embodiment in which the cooler 200 is installed at the rear end of the drying furnace 160 before performing room temperature rolling after drying the single-sided coated electrode plate, and FIG. 13 illustrates an embodiment in which the coolers 200 and 200′ are installed at the rear end of the second drying furnace 160′ for the second side before performing room temperature rolling after drying the first side and the second side of the double-coated electrode plate.

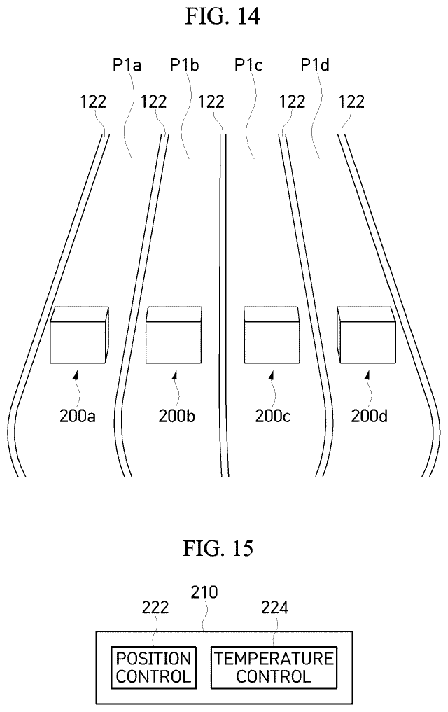

FIG. 14 is a schematic diagram of an embodiment that may be used when one electrode plate substrate has multiple coated portions 124a, 124b, 124c, and 124d coated in multiple rows in the transverse direction (TD).

Each of the coated portions 124a, 124b, 124c, and 124d has uncoated portions 122 interposed therebetween, and coolers 200a, 200b, 200c, 200d may be individually installed for the coated portions 124a, 124b, 124c, and 124d, respectively. In this embodiment, each of the coolers 200a, 200b, 200c, 200d may individually receive different type of control (e.g., cooler activation/deactivation, temperature control, position change, etc.) by the controller 210.

FIG. 15 is a schematic configuration diagram of the controller 210.

The controller 210 may include a position control unit 222 and a temperature control unit 224. As mentioned above, the position control unit 222 may control the vertical position, transverse direction position, longitudinal position, etc. of the cooler 200. The temperature control unit 224 may control the temperatures of the cooler 200 and the warmer 218 in conjunction with the first temperature sensor 212 and the second temperature sensor 220.

In various embodiments, the controller 210 may be a physically independent unit or may be integrated into a control device that controls operation of the secondary battery manufacturing apparatus.

A secondary battery manufacturing method according to embodiments of the present disclosure will be described.

According to embodiments of the secondary battery manufacturing method, coating a mixture on a substrate for manufacturing an electrode plate of an electrode assembly of a secondary battery and discharging the electrode plate may be performed, and the brittleness of the electrode plate may be improved (or reduced) by cooling the electrode plate discharged from the coating step.

In some embodiments, heat may be applied to the coated electrode plate and the coated electrode plate may be rolled after the coating step. In such an embodiment, the cooling may be performed after the rolling to cool the electrode plate.

Furthermore, in some embodiments, the coated electrode plate may be dried after the coating step. In such an embodiment, the cooling occurs after the drying to cool the electrode plate. The coated electrode plate may be rolled after it is cooled, and the rolling may be room temperature rolling.

Furthermore, in some embodiments, the electrode plate may be warmed to increase the temperature of the electrode plate after its temperature has been lowered by the cooling.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

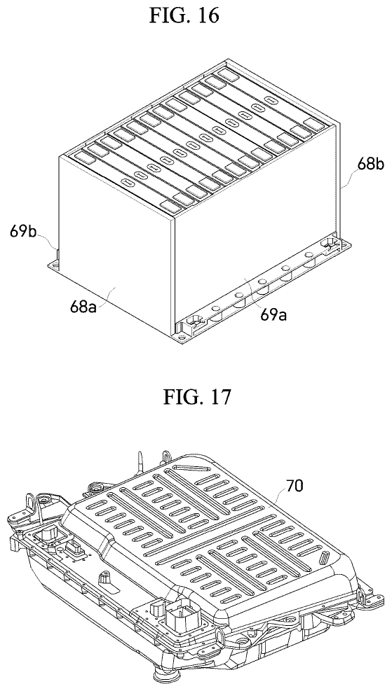

FIG. 16 is a perspective view of a secondary battery module in which prismatic secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting them together. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

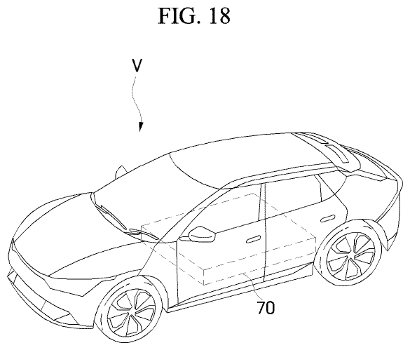

FIG. 17 is a perspective view of a battery pack 70 according to embodiments of the present disclosure. Referring to FIG. 17, the battery pack 70 may include an assembly to which individual batteries are electrically connected and a pack housing accommodating the same. In the drawings, for convenience of illustration, components including a bus bar, a cooling unit, external terminals for electrically connecting batteries, etc., are not shown.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 18 shows a vehicle V that includes the battery pack 70 shown in FIG. 17 on the lower body thereof. The vehicle V may operate by (e.g., may be powered by) receiving power from the battery pack 70.

Embodiments of the present disclosure solves reduce the brittleness of an electrode plate due to binder crystallization when the electrode plate is moved from a high temperature state (or environment) to a low temperature state (or environment) through a drying furnace or heated rolling, thereby reducing breakage and fracture of the electrode plate when a secondary battery is manufactured and improving the performance, extending the lifespan, and increasing the stability of the manufactured secondary battery.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery manufacturing apparatus comprising:
a coating unit configured to coat a mixture on a substrate of an electrode plate of an electrode assembly of a secondary battery and to discharge the coated electrode plate; and
a cooler configured to cooling the coated electrode plate to improve brittleness of the electrode plate.

2. The secondary battery manufacturing apparatus as claimed in claim 1, further comprising a press unit configured to roll the coated electrode plate,
wherein the cooler is configured to cool the coated and rolled electrode plate.

3. The secondary battery manufacturing apparatus as claimed in claim 1, further comprising a drying furnace configured to dry the coated electrode plate,
wherein the cooler is configured to cool the coated and dried electrode plate.

4. The secondary battery manufacturing apparatus as claimed in claim 1, wherein the cooler is configured to cool at least one of a first surface and a second surface of the coated electrode plate.

5. The secondary battery manufacturing apparatus as claimed in claim 1, wherein the cooler is spaced apart from a surface of the electrode plate in a range of 1 cm to 10 cm.

6. The secondary battery manufacturing apparatus as claimed in claim 1, further comprising a controller configured to control at least one of activation or deactivation, position movement, and temperature adjustment of the cooler.

7. The secondary battery manufacturing apparatus as claimed in claim 2, wherein the press unit comprises a preheating roll and a main roll, and
wherein a temperature of the preheating roll is in a range of 80° C. to 150° C. and a temperature of the main roll is in a range of 60° C. to 100° C.

8. The secondary battery manufacturing apparatus as claimed in claim 1, wherein the cooler has a transverse direction length that is equal to or larger than a width of the electrode plate.

9. The secondary battery manufacturing apparatus as claimed in claim 1, wherein the cooler has a machine direction length in a range of 5 cm to 30 cm.

10. The secondary battery manufacturing apparatus as claimed in claim 1, further comprising a first temperature sensor configured to measure a temperature of the electrode plate cooled by the cooler.

11. The secondary battery manufacturing apparatus as claimed in claim 1, wherein the cooler comprises a curtain between a lower part of the cooler and the electrode plate to form a space between the lower part of the cooler and the electrode plate.

12. The secondary battery manufacturing apparatus as claimed in claim 1, further comprising a cooling roll configured to cool the electrode plate by contacting the electrode plate.

13. The secondary battery manufacturing apparatus as claimed in claim 1, further comprising a warmer configured to warm the electrode plate whose temperature has been lowered by the cooler.

14. The secondary battery manufacturing apparatus as claimed in claim 13, further comprising a second temperature sensor configured to measure the temperature of the electrode plate whose temperature has been increased by the warmer.

15. The secondary battery manufacturing apparatus as claimed in claim 3, wherein the drying furnace comprises a first drying furnace configured to dry a first side of the electrode plate and a second drying furnace configured to dry a second side of the electrode plate, and
wherein the cooler is configured to cool the electrode plate discharged from the second drying furnace.

16. The secondary battery manufacturing apparatus as claimed in claim 1, wherein the coating unit is configured to form a plurality of coated portions on the electrode plate, and
wherein the cooler comprises a plurality of coolers configured to cool the plurality of coated portions, respectively.

17. A secondary battery manufacturing method comprising:
coating a mixture on a substrate of an electrode plate of an electrode assembly of a secondary battery and discharging the coated electrode plate; and
cooling the coated electrode plate to improve brittleness of the electrode plate.

18. The secondary battery manufacturing method as claimed in claim 17, further comprising rolling the coated electrode plate,
wherein the cooling of the coated electrode plate occurs after the rolling of the coated electrode plate.

19. The secondary battery manufacturing method as claimed in claim 17, further comprising drying the coated electrode plate,
wherein the cooling of the electrode plate occurs after the drying of the coated electrode plate.

20. The secondary battery manufacturing method as claimed in claim 17, further comprising warming the electrode plate after the cooling of the electrode plate.
